(19) United States
(12) Patent Application Publication
(10) Pub. No.: US 2010/0303274 A1
(43) Pub. Date: Dec. 2, 2010

(54) Microphone Having Reduced Vibration Sensitivity

(76) Inventors: William Ryan, Elgin, IL (US); Anthony Minervini, Palos Heights, IL (US)

Correspondence Address: FITCH EVEN TABIN & FLANNERY, 120 SOUTH LASALLE STREET, SUITE 1600, CHICAGO, IL, 60603-3406, US

(21) Appl. No.: 12/781,918

(22) Filed: May 18, 2010

Related U.S. Application Data
(60) Provisional application No. 61/179,064, filed on May 18, 2009.

(51) Int. Cl. H04R 1/02

(52) U.S. Cl. 381/361

(57) ABSTRACT

A microphone assembly includes a first transducer and a second transducer. The first transducer is coupled to a first substrate layer on a first side of the first substrate layer. The second transducer is coupled to a second substrate layer on a second side of the second substrate layer. The first side and the second side are opposite to each other. The first substrate layer and the second substrate layer are substantially parallel and mechanically coupled. The first transducer and the second transducer have a shared volume and this shared volume is one of a front volume or a rear volume.

### CROSS REFERENCE TO RELATED APPLICATION

This patent claims benefit under 35 U.S.C. §119 (e) to U.S. Provisional Application No. 61/179,064 entitled “Microphone Having Reduced Vibration Sensitivity” filed May 18, 2009 having attorney docket number P09012 the content of which is incorporated herein by reference in its entirety.

### TECHNICAL FIELD

This present invention relates to a microphone design with two or more transducer elements to minimize vibration sensitivity.

### BRIEF DESCRIPTION OF THE DRAWINGS

For a more complete understanding of the disclosure, reference should be made to the following detailed description and accompanying drawings wherein:

FIG. 1 illustrates a cross-sectional view of a microphone utilizing multiple transducers to minimize vibration sensitivity in an embodiment of the present invention;

FIG. 2 illustrates a cross-sectional view of another microphone having an alternate porting scheme in an embodiment of the present invention;

FIG. 3 illustrates a cross-sectional view of another microphone utilizing a transducer array in an embodiment of the present invention;

FIG. 4 illustrates an equivalent circuit diagram of the embodiment of FIG. 1 in response to an acoustic pressure;

FIG. 5 illustrates an equivalent circuit diagram of the embodiment of FIG. 1 in response to a vibration stimulus;

FIG. 6 illustrates a cross-sectional view of a microphone assembly in an embodiment of the present invention;

FIG. 7 illustrates a cross-sectional view of another microphone assembly in an embodiment of the present invention; and

FIG. 8 illustrates a cross-sectional view of yet another microphone assembly in an embodiment of the present invention.

Skilled artisans will appreciate that elements in the figures are illustrated for simplicity and clarity. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

While the present disclosure is susceptible to various modifications and alternative forms, certain embodiments are shown by way of example in the drawings and these embodiments will be described in detail herein. It will be understood, however, that this disclosure is not intended to limit the invention to the particular forms described, but to the contrary, the invention is intended to cover all modifications, alternatives, and equivalents falling within the spirit and scope of the invention defined by the appended claims.

In many of these embodiments, a microphone assembly includes a first transducer and a second transducer. The first transducer is coupled to a first substrate layer on a first side of the first substrate layer. The second transducer is coupled to a second substrate layer on a second side of the second substrate layer. The first side and the second side are opposite to each other. The first substrate layer and the second substrate layer are substantially parallel and mechanically coupled. The first transducer and the second transducer have a shared volume and this shared volume is one of a front volume or a rear volume.

In some aspects, the microphone assembly includes a third transducer coupled to the first substrate layer, and a fourth transducer that is coupled to the second substrate layer. The third and fourth transducers are in communication with the shared volume. In some examples, the total number of transducers is an even integer and the total number of transducers is distributed equally (i.e., in equal numbers) as between the first substrate layer and the second substrate layer.

In other examples, the first substrate layer is a baffle plate. In still other aspects, the microphone assembly includes a cover. The cover substantially encloses the first transducer, and the cover has an acoustic port. In still other examples, the acoustic port is disposed between the first transducer and the second transducer.

In others of these embodiments, a microphone assembly includes a first transducer and a second transducer. The first transducer is coupled to a first substrate layer on a first side of the first substrate layer. The second transducer is coupled to a second substrate layer on a second side of the second substrate layer. The first side and the second side are opposite to each other. The first substrate layer and the second substrate layer are substantially parallel and mechanically coupled. An acoustic inlet exists between the first substrate layer and the second substrate layer. The acoustic inlet communicates acoustic signals to the first transducer and the second transducer.

In some aspects, the first transducer and the second transducer have a shared front volume. In other aspects, the microphone assembly further includes a cover that substantially encloses the first transducer. In other examples, the microphone assembly further includes an acoustic port that is formed in the cover. In still other aspects, the first transducer and the second transducer are aligned.

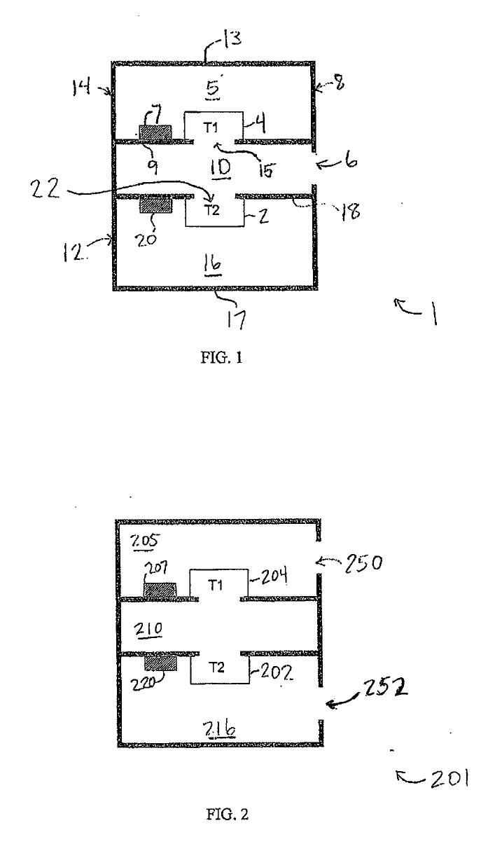

FIG. 1 illustrates a microphone 1 having multiple acoustic transducer elements 2, 4 configured to reduce vibration sensitivity and improve signal to noise ratio. The microphone package or assembly 1 which may be constructed from materials such as, for example, stainless steel or other stamped metal, or the like. Sound, in the form of acoustic waves, may enter into the microphone assembly 1 through an acoustic port 6 located within a center volume 10 located in the housing 12 between top and bottom opposing transducer elements 2 and 4. In an embodiment, a cover may provide a portion of the housing. A top volume 5 or cavity may be defined as an area extending horizontally from a side 8 of the microphone 1 to a side 14, and vertically from a substrate, such as a baffle plate 9 to a top wall or surface 13 of the microphone 1. In an embodiment, the substrate may be a single layer or may be comprised of multiple layers. The baffle plate 9 resides between the top volume 5 and center or shared volume 10 and may provide acoustic isolation between the two volumes. In this embodiment, the volume 10 is a shared front volume. The top baffle plate 9 may be constructed from materials such as metal, ceramic, FR-4, or the like. Positioned upon the top baffle plate 9 is a top acoustic transducer element 4 which may be in connection with the baffle plate 9 via, for example, surface mounting, adhesive bonding, or any other method contemplated by one of ordinary skill in the art. The top transducer element 4 may be, for example, a MEMS microphone transducer. A top buffer integrated circuit 7 is adjacent to the top transducer element 4 and electrically connected to the transducer element 4 via, for example, wire bonding or embedded traces (not shown) within the baffle plate 9. The top buffer integrated circuit 7 may be in connection with the baffle plate 9 via, for example, surface mounting, adhesive bonding, or any other method contemplated by one of ordinary skill in the art. The top acoustic transducer element 4 contains a sound port 15 to allow sound waves to impinge upon the transducer element 4, resulting in an electrical output which is buffered by the buffer integrated circuit 7. The top transducer element 4 and top buffer integrated circuit 7 are housed within the top volume 5.

A bottom volume 16 may be defined as an area extending horizontally from side 8 of the microphone assembly 1 to the side 14, and vertically from a second substrate, such as a baffle plate 18 to a surface 17 of the microphone 1. The baffle plate 18 resides between the bottom volume 16 and center volume 10 and may provide acoustic isolation between the two volumes. The bottom baffle plate 18 may be constructed from materials such as metal, ceramic, FR-4, or the like. Positioned upon the bottom baffle plate 18 is a bottom acoustic transducer element 2 which may be in connection with the baffle plate 18 via, for example, surface mounting, adhesive bonding, or any other method contemplated by one of ordinary skill in the art. The bottom transducer element 2 may be, for example, a MEMS microphone transducer. A bottom buffer integrated circuit 20 is adjacent to the bottom transducer element 2 and electrically connected to the transducer element 2 via, for example, wire bonding or embedded traces within the baffle plate 18. The bottom buffer integrated circuit 20 may be in connection with the baffle plate 18 via, for example, surface mounting, adhesive bonding, or any other method contemplated by one of ordinary skill in the art. The bottom acoustic transducer element 2 contains a sound port 22 to allow sound to impinge upon the transducer element 2, resulting in an electrical output which is buffered by the buffer integrated circuit 20. The bottom transducer element 2 and bottom buffer integrated circuit 20 are housed within a bottom cavity or volume 16. It is important to note that the transducer elements 2, 4 may or may not be aligned vertically along a surface of their respective baffle plates. In fact, it is contemplated that the transducer elements may be positioned along the baffle plates at different locations, in a non-parallel, non-linear, or otherwise non-aligned arrangement.

The top baffle plate 9 and bottom baffle plate 18 may be oriented approximately 180 degrees with respect to each other. In an embodiment, the top buffer integrated circuit 7 and the bottom integrated circuit 20 are fabricated from the same design and well matched with regards to gain and phase response. Referring to FIG. 4, a circuit diagram 290 is provided representing the summing of the outputs of top buffer integrated circuit 7 and bottom integrated circuit 20 results in a microphone 1 that achieves an improvement in signal to noise ratio (SNR) versus the performance of a single microphone alone. As shown in the configuration shown in FIG. 1, a time-varying acoustic pressure arriving at the acoustic port 6 will yield transducer output signals A and B that are in-phase. Summing the outputs will yield an output that is calculated by the equation OUT=A*G1+B*G2. For unity gain buffers where G1=G2=1 and where transducer elements A and B are matched, OUT=2*A. In other words, the output of the system is double that of a single transducer system. It follows that the uncorrelated noise response of the summed system will add to be OUT²=A²+B², or OUT=sqrt(2)*A. In considering the pressure and noise response, the total SNR benefit can be (2*A)/(sqrt(2)*A), or 3 dB better than a single transducer system alone.

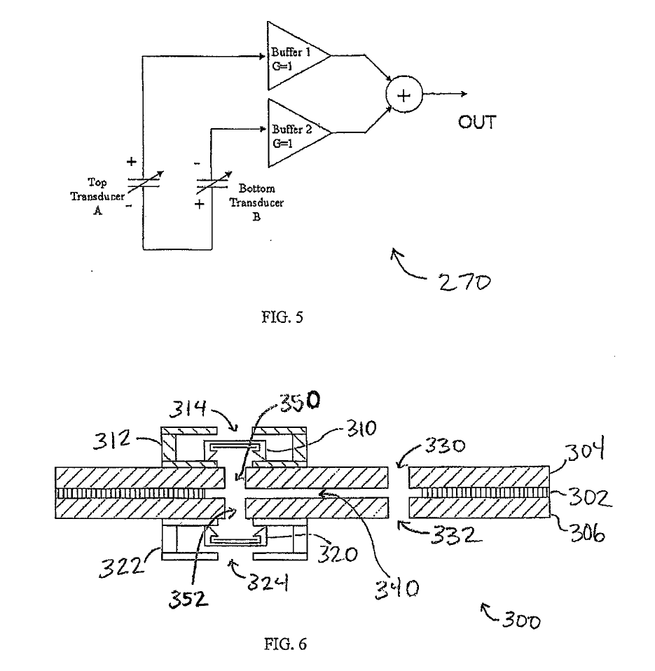

FIG. 5 shows an equivalent vibration schematic 270 for the system illustrated in FIG. 1. For a vibration induced in the system normal to top transducer element 4 and bottom transducer element 2, the 180 degree opposed physical orientation of the transducers results in an output of one transducer that is out of phase with the other transducer. The resultant output through the summing network is OUT=A*G1−B*G2 in response to vibration. For unity gain buffers where G1=G2=1 and transducer elements A and B are matched, OUT=A−A=0. In other words, the output of the system is theoretically nil. The inversion of one transducer allows cancellation of the vibration-induced signal.

In an embodiment, MEMS transducer elements can be used. By utilizing MEMS transducer elements, certain benefits can be realized. For example, the smaller size of MEMS acoustic transducers may allow the use of multiple transducer elements to maintain a small overall package. Since MEMS transducers use semiconductor processes, elements within a wafer can be well matched with regards to sensitivity over the human audible frequency bandwidth, as is commonly known as 20 Hz to 20 kHz. Sensitivity of condenser microphone transducers is determined by diaphragm mass, compliance, and motor gap. These parameters may be controlled, since they are related to deposition thickness and material properties of the thin films that semiconductor fabrication processes use to deposit the materials used in MEMS and semiconductor devices. Use of well-matched transducers may lead to optimal performance for vibration sensitivity.

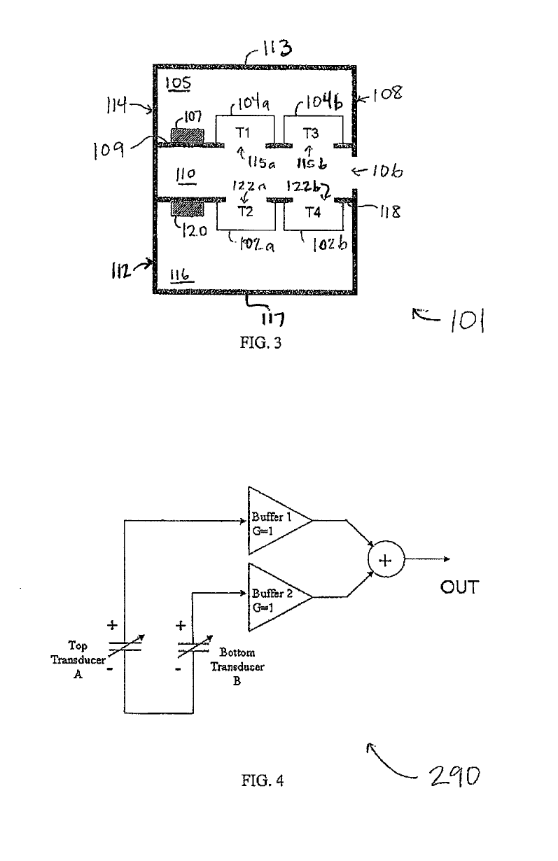

Multiple matched transducer elements summed in a single microphone package may be able to achieve further improvement in SNR. The degree of improvement may be directly related to the number of transducers used. FIG. 3 illustrates a microphone 101 in another embodiment of the present invention. The microphone 101 is similar in construction to the foregoing microphone 1, and therefore like elements are identified with a like reference convention. Transducers 104a, 104b are connected to baffle plate 109. Transducers 102a, 102b are connected to baffle plate 118. All of the transducers 104a, 104b, 102a, 102b, have a shared volume, in this instance, shared front volume 110. When the acoustic responses are summed, as shown in FIG. 4, the degree of SNR improvement may increase with the number of acoustic transducer elements, based on the formulae: SNR=S/N where S=A+B+ . . . +n and N²=A²+B²+ . . . +n². “n” represents the number of total transducer elements used. Higher SNR may be achieved with even greater number of transducers than those shown in the embodiment of FIG. 3. As previously mentioned, it should be noted that the transducer elements may or may not be aligned vertically along a surface of their respective baffle plates. In fact, it is contemplated that the transducer elements may be positioned along the baffle plates at different locations, in a non-parallel, non-linear, or otherwise non-aligned arrangement.

As shown in the example of FIG. 3, multiple transducer elements are distributed equally on the first and second substrate layer. This particular arrangement significantly improves the signal-to-noise ratio (SNR) while maintaining improved vibration performance. Generally speaking, an even total number of transducers are deployed on two substrate layers (e.g., n=2, 4, 6, or 8 and so forth, where n is the total number of transducers used). In the particular example of FIG. 3, n=4 and two transducers are disposed on each substrate layer.

FIG. 2 illustrates another microphone 201 in an embodiment of the present invention. The microphone 201 is similar in construction to the foregoing microphones 1, 101, and therefore like elements are identified with a like reference convention. The microphone 201 has a port 250 in a top volume 205 and a port 252 in a bottom volume 216. Between the top and bottom volumes is a center volume 210. In this embodiment, the center volume 210 is a shared rear volume. In this embodiment, the center volume 210 does not contain an acoustic port. Like microphone 1, FIG. 4 represents the equivalent circuit model for microphone 201.

FIG. 6 illustrates a cross-sectional view of a microphone assembly 300 in an embodiment of the present invention. The assembly 300 has a spacer layer 302 provided between two substrate layers 304, 306. The spacer layer 302 may be constructed from polyimide, or like material or materials. The polyimide layer 302 may be laser cut and may act as an adhesive. The substrate layers 304, 306 may or may not both be constructed from PCB materials such as FR-4, PTFE, Polyimide, or Ceramic Substrate Materials such as Alumina or the like. Transducer elements 310, 320 may be mounted or otherwise attached to the substrate layers 304, 306, respectively. The transducer elements 310, 320 may be, for example, MEMS transducer elements. Packages 312, 322 may be provided to encase the transducer elements 310, 320, respectively. The packages may provide a cover for the transducers 310, 320. The packages 312, 322 may have ports 314, 324. Acoustic ports 330, 332 may be created within the substrate layers 304, 306 to enable acoustic waves to enter into the microphone assembly 300. The acoustic waves may travel along an acoustic pathway 340 and pass through acoustic inlets 350, 352 to the transducer elements 310, 320. This embodiment may allow the user to further modify the response by connecting additional volumes or channels to ports 314 and 324. This embodiment may also display directional behavior.

FIG. 7 illustrates a cross-sectional view of a microphone assembly 400 in an embodiment of the present invention. The microphone assembly 400 is similar in construction to the foregoing microphone assembly 300, and therefore like elements are identified with a like reference convention. In this embodiment, only the port 424 is provided in package 422. This embodiment may allow the user to further modify the response by connecting additional volumes or channels to port 424. This embodiment may also display directional behavior.

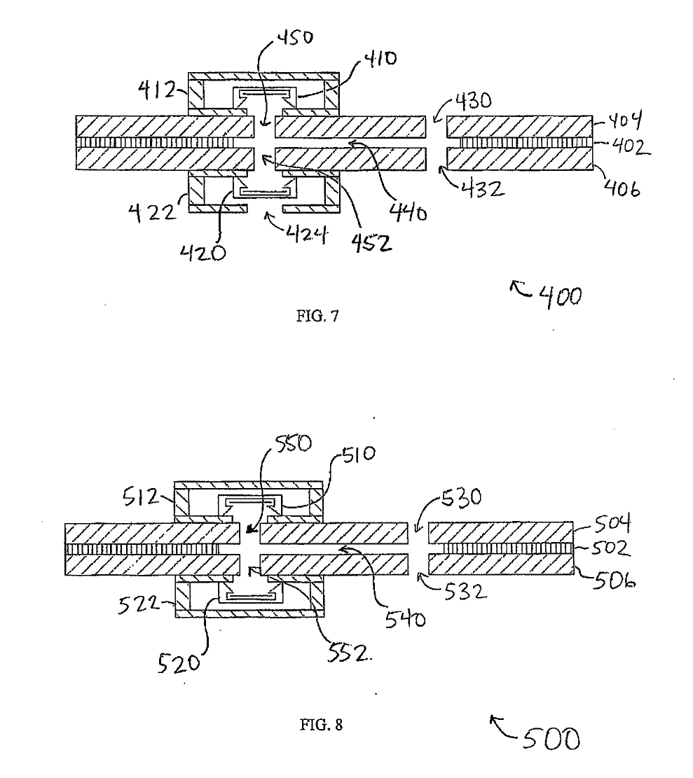

FIG. 8 illustrates a cross-sectional view of a microphone assembly 500 in an embodiment of the present invention. The microphone assembly 500 is similar in construction to the foregoing microphone assemblies 300, 400, and therefore like elements are identified with a like reference convention. In this embodiment, no ports are provided in package 512, 522. This embodiment may operate similar to the embodiment of FIG. 1. The shape of the channel 540 may affect the frequency response as well; thus, this may be a method of acoustically filtering out some frequency ranges.

Preferred embodiments of this invention are described herein, including the best mode known to the inventors for carrying out the invention. It should be understood that the illustrated embodiments are exemplary only, and should not be taken as limiting the scope of the invention.

What is claimed is:

1. A microphone assembly comprising:
a first transducer coupled to a first substrate layer on a first side of the first substrate layer;
a second transducer coupled to a second substrate layer on a second side of the second substrate layer;
wherein the first side and the second side are opposite to each other;
wherein the first substrate layer and the second substrate layer are substantially parallel and mechanically coupled;
wherein the first transducer and the second transducer have a shared volume, such shared volume being one of a front volume or a rear volume.

2. The microphone assembly of claim 1 further comprising:
a third transducer coupled to the first substrate layer, and a fourth transducer coupled to the second substrate layer, wherein the third and fourth transducers are in communication with the shared volume.

3. The microphone assembly of claim 1 wherein the first substrate layer is a baffle plate.

4. The microphone assembly of claim 1 further comprising:
a cover substantially enclosing the first transducer, wherein the cover has an acoustic port.

5. The microphone assembly of claim 4 wherein the acoustic port is between the first transducer and the second transducer.

6. The microphone assembly of claim 1 where the total number of transducers is an even integer and the transducers are distributed in equal numbers as between the first substrate layer and the second substrate layer.

7. A microphone assembly comprising:
a first transducer coupled to a first substrate layer on a first side of the first substrate layer;
a second transducer coupled to a second substrate layer on a second side of the second substrate layer;
wherein the first side and the second side are opposite to each other;
wherein the first substrate layer and the second substrate layer are substantially parallel and mechanically coupled;
wherein an acoustic inlet exists between the first substrate layer and the second substrate layer;
and wherein the acoustic inlet communicates acoustic signals to the first transducer and the second transducer.

8. The microphone assembly of claim 7 wherein the first transducer and the second transducer have a shared front volume.

9. The microphone assembly of claim 7 further comprising:
a cover substantially enclosing the first transducer.

10. The microphone assembly of claim 9 further comprising:
an acoustic port formed in the cover.

11. The microphone assembly of claim 7 wherein the first transducer and the second transducer are aligned.
